(19) United States
(12) Patent Application Publication
(10) Pub. No.: US 2018/0146679 A1
(43) Pub. Date: May 31, 2018

(54) ANTIMICROBIAL CELLULOSE-BASED MATERIAL

(71) Applicants: COMMISSARIAT A L'ENERGIE ATOMIQUE ET AUX ENERGIES ALTERNATIVES, Paris (FR); UNIVERSITE GRENOBLE ALPES, Saint Martin d'Heres (FR)

(72) Inventors: Aurelien AUGER, Grenoble (FR); Delphine BOUTRY, Vinay (FR); Elise EYMARD-VERNAIN, Voiron (FR); Arnaud GUIOT, Saint Egreve (FR); Cecile LELONG, Saint Martin d'Uriage (FR)

(73) Assignees: COMMISSARIAT A L'ENERGIE ATOMIQUE ET AUX ENERGIES ALTERNATIVES, Paris (FR); UNIVERSITE GRENOBLE ALPES, Saint Martin d'Heres (FR)

(21) Appl. No.: 15/819,830

(22) Filed: Nov. 21, 2017

(30) Foreign Application Priority Data
Nov. 25, 2016 (FR) 16 61510

(51) Int. Cl. A01N 59/16; A01N 25/10; A01N 25/34; A23L 3/34; A23P 20/10

(52) U.S. Cl. CPC A01N 59/16; A01N 25/10; A23V 2002/00; A23L 3/34; A23P 20/105; A01N 25/34

(57) ABSTRACT

A use, as antimicrobial material, of semicrystalline nano- and/or microfibrillated cellulose to which silver nanoparticles are attached, the silver nanoparticles being present in a weight amount strictly greater than 1% and strictly less than 20% relative to the total weight of said cellulose, the material being obtained with a process including at least one step of microwave irradiation of an aqueous dispersion of semicrystalline nano- and/or microfibrillated cellulose supplemented with at least one silver salt, in the presence of a reducing agent. An antimicrobial composition including such an antimicrobial material and to the application thereof for forming an antimicrobial film or coating, in particular for an article for food-processing.

The present invention relates to the use, as antimicrobial material, of semicrystalline fibrillated nanocellulose to which silver nanoparticles are attached by microwave irradiation, in particular for application in the food-processing field.

For several years, scientists and manufacturers have been developing materials which are derived from plant biomass, or which are even biobased, as alternatives to oil products. In this respect, nanocellulose proves to be a material of great interest given that it is derived from renewable natural resources, and that it is biodegradable, recyclable and carbon-neutral.

Derived from cellulose, nanocellulose exists in two forms: on the one hand, semicrystalline cellulose microfibrils (MFC) and/or cellulose nanofibrils (NFC), and, on the other hand, cellulose nanocrystals or nanocrystalline cellulose (NCC or CNC). MFC and/or NFC, also called NMFC, are obtained by mechanical treatment, whereas it is a chemical process which results in the formation of NCC. FIG. 1 illustrates these two types of nanocellulose. They differ in particular by virtue of their microstructure, as reported in the article Xuezhu et al. [1].

Advantageously, nanocellulose, in particular semicrystalline nanocellulose, makes it possible to provide a property of impermeability, in particular to water, by virtue of its crystalline part, and an oxygen barrier property by virtue of its amorphous part. These barrier properties are all the more advantageous when the amorphous part possesses little free volume fraction and a high cohesive density.

These properties of nanocellulose are in particular exploited in the food sector. Thus, certain papers and/or films, in particular based on cellulose, dedicated to the food sector, may be covered with a thin layer of nanocellulose in order to provide a barrier effect against oxygen diffusion for example.

In addition to these water-impermeability and oxygen-barrier effect properties, it is also desirable for food papers and/or films to be able to have antibacterial properties, so as to enable longer term storage of the foods contained in these packagings.

With this aim, it has already been proposed to combine antibacterial agents with cellulose-based materials.

For example, mention may be made of the document Saini et al. [2] which proposes chemically functionalizing cellulose nanofibers with an antibacterial peptide, nisin.

It has also already been proposed to use silver nanoparticles, known for their bactericidal properties.

For example, Hinkov et al. [3] propose integrating microwave-synthesized silver nanoparticles into cellulose sheets for food-processing applications.

Mention may also be made of Berndt et al. [4] who propose preparing antimicrobial porous hybrids in the medical field, consisting of bacterial nanocellulose on which silver nanoparticles are immobilized. However, the immobilization of the silver nanoparticles to the bacterial nanocellulose involves a chemical modification of the nanocellulose with amine groups via the use of N,N′-carbonyldiimidazole. Moreover, the process for preparing the modified nanocellulose requires several chemical synthesis steps, is long and requires the use of DMSO solvent.

As regards Amini et al. [5], they propose an antimicrobial coating obtained by mixing silver nanoparticles and cellulose nanofibers for packaging papers. The nanocellulose thus impregnated with the silver nanoparticles is then deposited by filtration on paper. However, such a process poses control and reproducibility problems due in particular to the absence of affinity between the cellulose nanofibrils and the silver.

Still in the context of the use of metal nanoparticles for antibacterial purposes, mention may also be made of document EP 2 230 321 which targets a process for preparing metal nanoparticles on a support of biopolymer type, said biopolymer possibly being microcrystalline cellulose. Document CN 101 811 664 proposes, for its part, a method for preparing a silver/cellulose nanocomposite material based on microcrystalline cellulose. None of these documents relates to the preparation of semicrystalline cellulose microfibrils and/or of semicrystalline cellulose nanofibrils targeted in the context of the present invention.

The present invention provides a novel antibacterial cellulose-based material based on semicrystalline nano- and/or microfibrillated cellulose, the production of which is easy and which exhibits good antibacterial efficacy.

More particularly, according to a first of its aspects, it relates to the use, as antimicrobial material, of semicrystalline nano- and/or microfibrillated cellulose to which silver nanoparticles are attached, said silver nanoparticles being present in a weight amount strictly greater than 1% and strictly less than 20% relative to the total weight of said cellulose,

said material being obtained by means of a process comprising at least one step of microwave irradiation of an aqueous dispersion of semicrystalline nano- and/or microfibrillated cellulose, supplemented with at least one silver salt, in the presence of a reducing agent.

In the remainder of the text, the antimicrobial material according to the invention formed from semicrystalline nano- and/or microfibrillated cellulose to which silver nanoparticles are attached (anchored) is denoted “antimicrobial cellulose-based material”

The inventors have thus noted that it is possible to formulate a material based on semicrystalline nano- and/or microfibrillated cellulose which has good antimicrobial, in particular antibacterial, properties via the anchoring of silver nanoparticles by means of a process implementing microwave irradiation.

Advantageously, in the antimicrobial cellulose-based material of the invention, the silver nanoparticles are stably and homogeneously immobilized on the cellulose microfibrils and/or nanofibrils, said cellulose not being chemically or structurally modified.

In fact, the nanocellulose on which the silver nanoparticles are anchored, which is used as antimicrobial material according to the invention, is prepared by means of a process which does not cause any chemical and/or structural transformation or modification of the nanocellulose. The process for preparing the antimicrobial material is efficient, rapid and inexpensive, without constraint or extreme conditions.

More particularly, in the antimicrobial material according to the invention, the silver nanoparticles are immobilized on said cellulose microfibrils or nanofibrils via electrostatic forces, complexation phenomena and hydrogen bonds, and are permanently attached thereto.

The implementation of a microwave treatment for preparing the antimicrobial material according to the invention advantageously makes it possible to increase the binding energy, and also to improve the crystallization of the silver nanoparticles formed in situ.

Once the immobilization is stabilized in aqueous medium, the microwave-irradiation step allows permanent attachment of the silver nanoparticles to the nanocellulose. A 3D nanocellulose-based network is thus formed, which traps the silver nanoparticles. In this way, the silver nanoparticles are at the surface of and deep within the nanocellulose.

The microwave-irradiation step thus proves to be essential for ensuring permanent attachment of the silver nanoparticles to the NMFC fibers.

Furthermore, this preparation method makes it possible to obtain silver particles of nanometric sizes: since the precipitation of the inorganic species is virtually instantaneous in water under hydrothermal conditions, extremely short reaction times may be used, thereby making it possible to limit the nanoparticle growth.

Moreover, this preparation process makes it possible to achieve low levels of crystal defects. Indeed, because of the high temperatures and pressures, the presence of crystal defects in the materials thus used is observed very rarely, contrary to conventional synthesis techniques.

Furthermore, as illustrated in the examples which follow, the nanocellulose to which silver nanoparticles are attached according to the process of the invention has excellent antimicrobial, in particular antibacterial, properties, both with respect to Gram-positive bacteria and with respect to Gram-negative bacteria.

Without wishing to be bound by any theory, the antibacterial cellulose-based material according to the invention is capable of releasing Ag⁺ ions when the material is brought into contact with bacteria, without releasing the silver nanoparticles.

The antimicrobial material according to the invention may thus be used for many applications, in particular for conferring antibacterial properties on the packagings used in the food-processing industry.

More particularly, the antimicrobial cellulose-based material according to the invention may be used for forming all or part of an antimicrobial film or coating, in particular at the surface of a substrate, said substrate being more particularly a film, in particular of cellulose-based nature, such as a food film. Such a coating makes it possible to guarantee an antibacterial effect.

According to another of its aspects, the present invention relates to an antimicrobial composition comprising at least:

semicrystalline nano- and/or microfibrillated cellulose to which silver nanoparticles are attached in a weight content strictly greater than 1% and strictly less than 20% relative to the total weight of said cellulose, obtained according to the process defined above; and

at least one compound, termed mechanical reinforcement, capable of improving the mechanical properties of a coating formed from said composition.

As detailed in the remainder of the text, the antimicrobial composition may be either deposited via the aqueous route at the surface of a substrate according to methods known to those skilled in the art, for example by spraying, or used via the solid route, for example in the form of a self-supported coating or film.

Another subject of the invention is thus an antimicrobial film or coating formed from an antimicrobial composition as defined above.

Yet another subject of the invention is a process for preparing an antimicrobial film or coating as defined above, characterized in that it comprises at least one step (a) of applying, via the aqueous route, a composition as defined above to the surface of a substrate and a drying step (b) suitable for evaporating off said aqueous solvent(s).

According to another of its aspects, the invention also relates to a process that is of use for conferring antimicrobial, in particular antibacterial, properties on a substrate, in particular a film or paper, in particular of cellulose-based nature, comprising the application, at the surface of said substrate, of an antimicrobial film or coating according to the invention or as obtained according to the process defined above.

According to yet another of its aspects, it relates to an article, in particular for food processing, such as a food film, comprising a substrate coated with at least one antimicrobial film or coating according to the invention or obtained according to the process defined above.

Other characteristics, variants and advantages of the antimicrobial cellulose-based material according to the invention and of the use thereof will emerge more clearly on reading the description, the examples and the figures which follow, and which are given by way of nonlimiting illustration of the invention.

In the remainder of the text, the expressions “of between . . . and . . . ”, “ranging from . . . to . . . ” and “varying from . . . to . . . ” are equivalent and are intended to mean that the limits are included, unless otherwise mentioned.

Unless otherwise mentioned, the expression “containing/comprising a(n)” should be understood as “containing/comprising at least one”.

Antimicrobial Material

As indicated above, the antimicrobial cellulose-based material according to the invention is formed from semicrystalline nano- and/or microfibrillated cellulose on which silver nanoparticles are attached (anchored) by microwave.

The expression “semicrystalline nano- and/or microfibrillated cellulose” is intended to denote the cellulose in the form of nanofibrils and/or of microfibrils of semicrystalline cellulose.

In the remainder of the text, the semicrystalline nano- and/or microfibrillated cellulose will be denoted more simply by the names “nanocellulose” or “NMFC”.

In the context of the present invention, when the term “cellulose” is employed, it refers to any type of cellulose originating from any source known to those skilled in the art. In other words, any source of crude cellulose material may be used in the context of the present invention, whether it is for the preparation of the cellulose nanofibers or else for the preparation of the cellulose films that may be used as substrate to be coated with a thin layer of nanocellulose, as set out hereinafter. The starting material may originate from any plant material which contains cellulose. The plant material may be wood. The wood may originate from resinous trees such as spruce, pine, fur, larch, Douglas fir or hemlock spruce, or from hardwood trees such as birch, aspen, poplar, alder, eucalyptus or acacia, or from a mixture of resinous and broad-leaved trees. The plant material may also come from agricultural residues, from grasses or from other plant substances such as straw, leaves, bark, seeds, shells, flowers, vegetables or fruits of cotton, corn, wheat, oats, rye, barley, rice, flax, hemp, Manila hemp, sisal, jute, ramie, kenaf, bagasse, bamboo or reed.

The term “cellulose pulp” refers to cellulose fibers which are isolated from any cellulose-based raw material by means of processes known to those skilled in the art. Typically, the diameter of the fibers before any treatment in the context of the preparation of nanocellulose varies from 10 to 30 μm and the length of the fibers exceeds 500 μm.

The semicrystalline cellulose microfibrils and/or the semicrystalline cellulose nanofibrils (NMFC) considered in the context of the present invention are conventionally obtained by mechanical conversion of cellulose films, in contrast to the cellulose nanocrystals or nanocrystalline cellulose (NCC), not considered in the context of the present invention, which are obtained by chemical conversion of cellulose fibers.

The semicrystalline cellulose microfibrils and/or semicrystalline cellulose nanofibrils (NMFC) considered in the context of the present invention may be obtained according to any process known to those skilled in the art.

The NMFC generally have fiber lengths that may be between 0.5 and 100 μm, in particular between 1 and 50 μm, for example between 5 and 10 μm. Moreover, they generally have a diameter of between 1 and 100 nm, in particular between 5 and 50 nm, for example between 10 and 30 nm.

These dimensions are variable and may in particular depend on the cellulose pulp employed or else on the disintegration method used.

As mentioned above, the antibacterial material according to the invention is characterized by the presence of silver nanoparticles attached to the nanocellulose.

The silver nanoparticles are present in an amount strictly greater than 1% by weight and strictly less than 20% by weight relative to the total weight of said nanocellulose.

The term “total weight” of the nanocellulose is intended to mean the dry weight of semicrystalline nano- and/or microfibrillated cellulose, that is to say the weight of semicrystalline nano- and/or microfibrillated cellulose free of water.

Preferably, the weight amount of silver nanoparticles of the antimicrobial material according to the invention is greater than or equal to 2% relative to the total weight of nanocellulose. It is preferably less than or equal to 15% by weight.

According to one particular embodiment, the weight amount of silver nanoparticles of the antimicrobial material according to the invention is between 2% and 10% by weight, in particular between 2% and 8% by weight, and more particularly between 2% and 5% by weight, relative to the total weight of nanocellulose.

The term “nanoparticles” is intended to mean solid particles of nanometric sizes, that is to say of which at least one (and preferably all) of the dimensions is nanometric, that is to say less than one micrometer. The silver nanoparticles may more particularly have a size of between 20 and 200 nm, in particular between 50 and 150 nm, and more particularly of approximately 100 nm. The size may be evaluated by scanning electron microscopy (SEM).

Preparation of the Antimicrobial Cellulose-Based Material

As indicated above, the antimicrobial material according to the invention is obtained via a process which implements a step of microwave irradiation of an aqueous dispersion of semicrystalline nano- and/or microfibrillated cellulose, supplemented with at least one silver salt, in the presence of a reducing agent.

According to the process implemented according to the invention, the d(0) silver nanoparticles are synthesized in situ and bonded to the cellulose microfibrils or nanofibrils via weak bonds (Van der Waals, hydrogen bridges and electrostatic).

The process according to the present invention may in particular comprise the following steps consisting in:

(i) providing an aqueous dispersion of semicrystalline nano- and/or microfibrillated cellulose;

(ii) adding at least one silver salt with stirring until said silver salt has totally dissolved;

(iii) adding a reducing agent to the mixture thus obtained; and

(iv) subjecting said mixture to microwave irradiation under conditions conducive to the attachment of said silver nanoparticles to the nano- and/or microfibrillated cellulose.

Steps (i) to (iv) may be carried out under the following operating conditions.

The cellulose nanofibrils or microfibrils used are water-dispersible.

According to one particular embodiment, the content of nano- and/or microfibrillated cellulose in the aqueous dispersion is between 1% and 5% by weight, in particular between 2% and 4% by weight, and even more particularly between 2% and 3% by weight, relative to the total weight of the aqueous dispersion.

By way of silver salt, which acts as precursor, that may be used in the context of the present invention, mention may in particular be made of AgNO₃.

Of course, it is part of the competence of those skilled in the art to adjust the amount of silver salt introduced in step (ii) so as to obtain the desired silver content in the antimicrobial material according to the invention.

Without wishing to be bound by any theory, during the addition in step (ii) of the silver salt, the cellulose molecule, which has OH groups at the periphery of the monosaccharide structure, allows the complexation of the silver ions and the formation of bonds of cellulose-O—Ag type.

Step (iii) makes it possible to reduce the silver ions using a reducing agent. This step allows the formation and the attachment of d(0) silver nanoparticles to the cellulose micro- and nanofibrils via electrostatic forces, the complexation phenomenon and the formation of other hydrogen bridges.

Metal agglomerates of d(0) silver are thus obtained.

By way of reducing agent, mention may be made, for example, of hydrazine, N,N-diethylhydroxylamine, urea, thiourea and mixtures thereof.

It is understood that the reducing agent is not in the final antimicrobial cellulose-based material.

The microwave-irradiation step (iv) makes it possible to provide (d0) silver agglomerate crystallization energy in order to obtain crystalline (d0) silver nanoparticles which will be stable over time.

In other words, the d(0) crystalline silver nanoparticle agglomerates are initiated by stirring and reduction, then the microwave step makes it possible to crystallize them. The silver nanoparticles thus formed in situ are indissociable from the nanocellulose.

The process of the invention which implements microwave irradiation makes it possible to attach the silver nanoparticles to the NMFC fibers. It also allows a homogeneous distribution of the silver nanoparticles on the semicrystalline nano- and/or microfibrillated cellulose.

Those skilled in the art are able to adjust the microwave-irradiation conditions so as to obtain a permanent attachment of the silver nanoparticles to the nanocellulose fibers.

At the end of the microwave irradiation, the silver nanoparticles thus remain indissociable from the nano- and/or microfibrillated cellulose.

In particular, the microwave irradiation can have energy of between 200 and 1000 W, in particular between 350 and 850 W, for example between 500 and 750 W.

The duration of subjection to the microwave irradiation may be between 0.5 and 10 minutes, in particular between 1 and 5 minutes and more particularly between 1 and 2 minutes.

As mentioned above, at the end of this process, a cellulose-based material to which silver particles are permanently anchored at the surface and deep within is obtained.

Application

The antimicrobial cellulose-based material according to the invention has a particularly advantageous application in the field of the food-processing industry.

The invention thus relates more particularly to an antimicrobial material for an inert material object.

The term “inert material object” is intended to mean herein an object made of inert materials, that is to say matter that is not living or not biological or not derived from living or biological matter.

The antimicrobial material according to the invention may more particularly be used for forming all or part of an antimicrobial film or coating, in particular at the surface of a substrate such as a food film of cellulose-based nature.

Such an antimicrobial film or coating advantageously combines the properties inherent in the nanocellulose, namely water-impermeability and an oxygen-barrier property, with good antimicrobial properties.

The term “antimicrobial” film or coating is intended to mean that the external surface of the substrate on which the film or coating according to the invention is applied is active against microbes so as to prevent the development and propagation of said microbes with the surface of said substrate.

As illustrated in the examples which follow, the antimicrobial material is active both with respect to Gram-positive bacteria and with respect to Gram-negative bacteria.

According to another of its aspects, the invention relates to an antimicrobial, in particular antibacterial, composition comprising, in an aqueous medium, at least:

one antimicrobial cellulose-based material according to the invention obtained by means of a process as described above; and

at least one compound, termed mechanical reinforcement, capable of improving the mechanical properties (for example rigidity, resistance to abrasion, to scratches and/or to wearing) of a film or coating formed from the composition.

The antimicrobial composition according to the invention may be in liquid form, said composition then comprising one or more solvents, in particular aqueous solvents, for example water.

Such a composition in liquid form may be directly prepared by addition of one or more mechanical reinforcements to the aqueous dispersion of nanocellulose to which silver nanoparticles are attached, obtained at the end of the microwave treatment of the process for preparing the antimicrobial material described above.

Alternatively, the antimicrobial composition may be in solid form (that is to say free of solvents). Such a solid composition may for example be obtained after drying of a liquid composition, for example of an aqueous dispersion as described above, in order to remove said aqueous solvent(s).

The compounds, termed mechanical reinforcements, used in an antimicrobial composition according to the invention are more particularly of polymeric nature. They may for example be chosen from polymer nanoparticles such as nanoparticles or “beads” of natural or synthetic latex, polyvinylpyrrolidone (PVP), polyvinyl alcohol (PVA) and mixtures thereof.

The latex may for example be in the form of particles having a diameter of between 100 nm and 2 μm.

These compounds, generally used so as to make it possible to improve the mechanical properties of a film formed from film-forming compounds, in particular from cellulose, are commonly referred to as “mechanical reinforcements”.

They may be present in a content of between 0.5% and 5% by weight, relative to the total dry weight of the antimicrobial composition according to the invention.

The term “dry” weight is intended to mean the weight of the composition free of solvent, in particular free of aqueous solvent.

In the case of the use, jointly with the antimicrobial cellulose-based material according to the invention, of one or more mechanical reinforcements as described above, the composition used for forming an antimicrobial coating preferably also comprises one or more surfactant(s), in particular non-ionic surfactant(s), so as to optimize the antibacterial properties of the film or coating obtained.

The addition of surfactant(s) makes it possible in particular to promote the dispersion of the nanocellulose in the case of the use of the antimicrobial composition via the aqueous route.

The surfactants considered according to the invention are more particularly “detergent” compounds. The name “detergents” is known in biology and biochemistry for denoting mild surfactants used to promote cell membrane lysis and the dissolving of the intracellular material.

Such detergents may be neutral, anionic, cationic or else zwitterionic and are well known to those skilled in the art.

Preferably, the detergent used is chosen from non-ionic detergents. Non-ionic detergents are considered to be mild surfactants.

The non-ionic detergents of the antimicrobial composition according to the invention may be more particularly chosen from Tween® 80 or polysorbate 80 (polyoxyethylene sorbitan monooleate), Tween® 20 (polyoxyethylene sorbitan monolaurate), Triton® X 100 (octoxinol 10), Pluronic® F68 (polyethylene-polypropylene glycol), n-dodecyl-β-D-maltoside (DDM), 3-[(3-cholamidopropyl)dimethylammonio]-1-propanesulfonate, more well known as CHAPS, and mixtures thereof.

Preferably, the non-ionic detergent is a detergent of the “Triton X” series, produced by polymerization of octylphenol with ethylene oxide, more preferentially Triton® X-100 sold by Union Carbide.

The antimicrobial composition of the invention may be applied in the liquid state (aqueous route) to a base substrate, for example to a film, in particular of cellulose-based nature.

Alternatively, the antimicrobial composition of the invention may also be used, by virtue of the presence of mechanical reinforcements as described above, in the form of a self-supported product, in particular in the form of a self-supported antimicrobial film, allowing its use in the solid state (solid route).

For the purposes of the invention, a product, in particular a film, is said to be “self-supported” when, by virtue of its mechanical properties, it acquires a cohesion which makes it handlable and transportable, without the presence of a reinforcing substrate.

Thus, according to another of its objects, the invention also relates to an antimicrobial film or coating formed from an antimicrobial composition according to the invention.

The antimicrobial film or coating formed according to the invention may have a thickness of between 1 and 500 μm, in particular between 10 and 100 μm, in particular between 50 and 100 μm.

The invention also relates to a process for preparing an antimicrobial film or coating as described above, comprising at least one step (a) of applying, via the aqueous route, an antimicrobial composition as defined above to the surface of a substrate, and a drying step (b) suitable for evaporating off said aqueous solvent(s).

As mentioned above, the antimicrobial composition used via the aqueous route comprises one or more aqueous solvents, in particular water.

Advantageously, it may be an aqueous dispersion comprising an antimicrobial cellulose-based material according to the invention, obtained at the end of the microwave treatment of the process for preparing the antimicrobial material described above, and supplemented with one or more mechanical reinforcements.

The antimicrobial composition according to the invention may be deposited via the aqueous route on a substrate, for example made of cellulose, by any suitable industrial process well known to those skilled in the art.

By virtue of its nanometric or micrometric size, the microfibrillated nanocellulose (NMFC) to which the silver nanoparticles are anchored, that is used according to the invention, has a very good affinity for the cellulose of the substrate during the depositing preparations.

Among these depositing techniques, mention may be made of dip-coating, depositing by spraying, spin depositing, spray-coating, inkjet coating, spin-coating, slot die coating, coating by impregnation, flow-coating, depositing by dipping or by screen printing, depositing by size-press, and bar-coating.

Preferably, the depositing may be carried out by bar-coating or size-press.

The antimicrobial composition according to the invention is thus capable of forming a coating (in other words a layer or a film) at the surface of a substrate.

More particularly, the antimicrobial material according to the invention may be of use in the preparation of articles for food processing, such as food-processing films.

The invention thus relates to an article, in particular for food processing, comprising a substrate coated with at least one antimicrobial film or coating as described above.

Among the substrates that may thus be covered, mention may in particular be made of substrates of cellulose-based nature, whether they are papers or films.

The substrate may in particular be an article for food processing, like a food film, in particular based on cellulose.

The invention will now be described by means of the following examples and figures, given by way of nonlimiting illustration of the invention.

### FIGURES

FIG. 1: illustration of the two known types of semicrystalline nanocelluloses CNC and NMFC;

FIG. 2: X-ray diffraction spectra obtained for a sample of nanocellulose, before and after anchoring of silver nanoparticles (5% by weight) according to the process of example 1;

FIG. 3: 3d Ag XPS spectrum obtained for a sample of nanocellulose after anchoring of silver nanoparticles according to the process of example 1;

FIG. 4: observation of the antibacterial efficacy of the samples of nanocellulose treated according to examples 1 and 2, with respect to Gram-positive bacteria (Bacillus subtilis);

FIG. 5: observation of the antibacterial efficacy of the samples of untreated nanocellulose and of the samples of nanocellulose incorporating silver nanoparticles (5% by weight) and gold nanoparticles (5% by weight), prepared according to examples 1 and 2, with respect to Gram-positive bacteria (Bacillus subtilis) and Gram-negative bacteria (Escherichia coli).

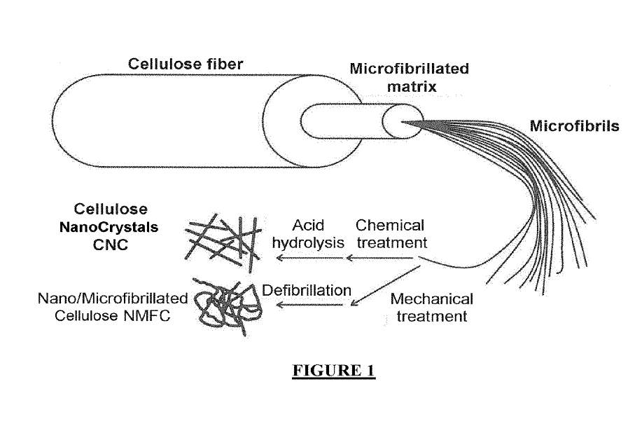

### EXAMPLES

### Example 1

Semicrystalline Fibrillated Nanocellulose Incorporating Silver Nanoparticles

The fibrillated nanocellulose (5 ml at a w/v concentration of 2.2 g/100 ml (%), i.e. 110 mg) is diluted in deionized water (30 ml) with vigorous stirring. 8.7 mg of AgNO₃ are added to the dispersion.

After obtaining total dissolution of the silver salt still with vigorous magnetic stirring, 1 drop of hydrazine (strong reducing agent) is added to the reaction medium. A color change is observed, typical of the formation of (d⁰) metal nanoagglomerates. The solution is then transferred into a Teflon minireactor and is subjected to microwave irradiation (1 minute at 750 W). After the treatment, the dispersion of nanocellulose to which (d⁰) silver nanoparticles are attached is recovered and is directly applicable.

According to the same protocol, various samples of nanocellulose incorporating variable amounts of silver nanoparticles (silver weight percentages of 0.1%, 0.5%, 1%, 2%, 3%, 4% and 20% relative to the dry weight of cellulose) were prepared by varying the amount of silver salt introduced.

Sample Analysis

The analysis of the samples by scanning electron microscopy SEM (LEO 1530 microscope, Electron Microscopy Ltd) and by transmission electron microscopy TEM (OSIRIS 1, Tecnai) makes it possible to confirm the presence of silver nanoparticles distributed in the nanocellulose.

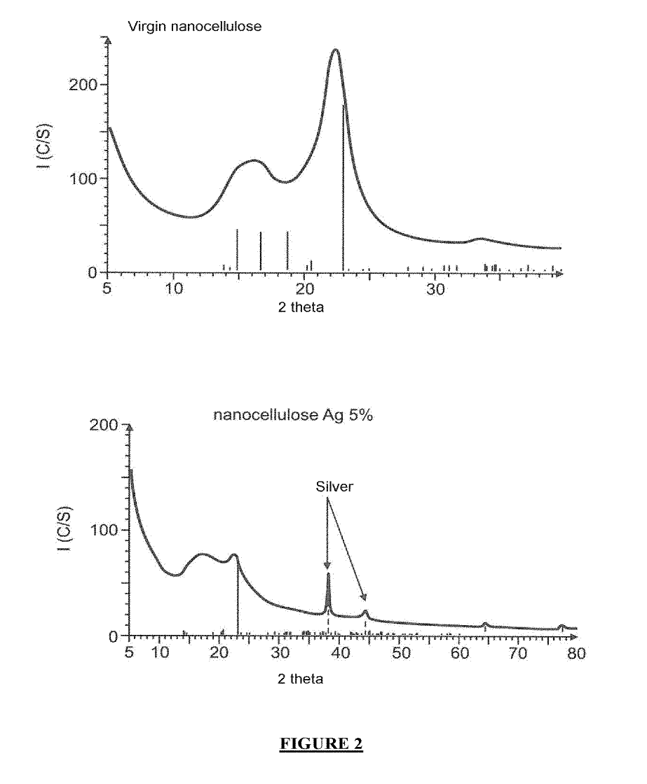

An X-ray diffraction analysis (Bruker D8-Advance, copper XR source) of the nanocellulose, before and after anchoring of the silver nanoparticles (5% by weight) according to the process described above (FIG. 2) makes it possible to verify that the nanocellulose retains the same semicrystalline structure before and after attachment of the silver nanoparticles.

The silver nanoparticles are of face-centered cubic type.

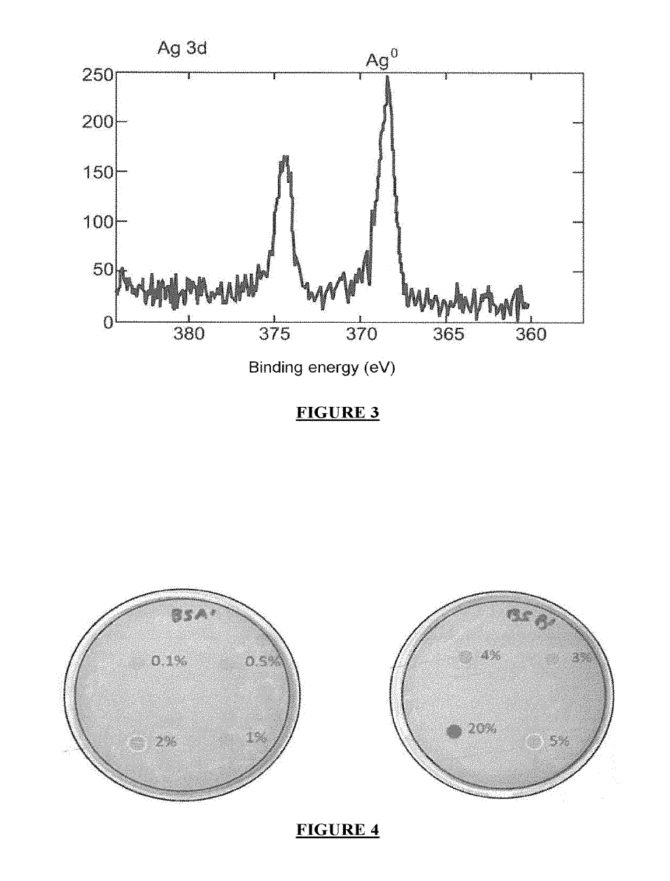

An XPS analysis (X-ray photoelectron spectroscopy, VersaProbe II, Phi) makes it possible to verify that the nanoparticles created in the nanocellulose are indeed metal nanoparticles, since “zero” silver Ag⁰ is detected (FIG. 3). There is no longer any silver salt, but indeed silver metal nanoparticles.

Finally, observations by SEM of the samples during the preparation of the nanocellulose, prior and subsequent to the microwave-irradiation step, make it possible to observe a better dispersion of the silver nanoparticles in the samples after microwave irradiation. On the other hand, many agglomerates can be observed in the materials that have not been subjected to microwave irradiation, located more particularly at the surface of the samples.

Analysis of the Antibacterial Efficacy of the Samples

The bacteriostatic efficacy was tested on two types of bacteria: Gram-positive bacteria (Bacillus subtilis) and Gram-negative bacteria (Escherichia coli).

750 μl of bacteria (Bacillus subtilis or Escherichia coli) precultured in rich liquid medium (LB=Luria Bertani) having an OD_{600 nm}=0.7-0.8 are uniformly inoculated on a petri dish (LB-agar=Luria Bertani-agar). After 30 minutes, the solid samples of nanocellulose (in the form of solid pellets) are deposited on the inoculated petri dishes. The whole is then incubated at 37° C. for 24 h to 72 h.

Conclusion

FIG. 4 is an image of the Gram-positive bacteria (Bacillus subtilis) cultures observed 24 hours after depositing of the samples of nanocellulose incorporating varied contents of silver nanoparticles.

Observation of the cultures shows an area of inhibition (clear ring characteristic of the absence of bacteria) around the samples of nanocellulose incorporating 2%, 3%, 4% and 5% by weight of silver.

Similar results are obtained for the cultures of Gram-negative bacteria (Escherichia coli).

Thus, the nanocelluloses prepared according to the invention, incorporating more than 1 by weight of silver nanoparticles, act as antibacterial material with respect to Gram-positive and Gram-negative bacteria.

### Example 2 (Counter Example)

Semicrystalline Fibrillated Nanocellulose on which Gold Nanoparticles are Anchored

By way of comparison, nanocellulose incorporating gold nanoparticles in a proportion of 5% by weight are prepared according to the same protocol as that described above in example 1.

The fibrillated nanocellulose (5 ml at a w/v concentration of 2.2 g/100 ml (%), that is to say 110 mg) is diluted in deionized water (30 ml) with vigorous stirring. 9.5 mg of HAuCl₄ are added to the dispersion.

After obtaining total dissolution of the gold salt still with vigorous magnetic stirring, 1 drop of hydrazine (strong reducing agent) is added to the reaction medium. A color change is observed, typical of the formation of (d⁰) metal nanoagglomerates. The solution is then transferred into a Teflon minireactor and is subjected to microwave irradiation (1 minute at 750 W). After the treatment, the dispersion of nanocellulose to which (d⁰) gold nanoparticles are attached is recovered and is directly applicable.

Analysis of the Antibacterial Efficacy

The bacteriostatic efficacy was tested on two types of bacteria; Gram-positive bacteria (Bacillus subtilis) and Gram-negative bacteria (Escherichia coli), as described in example 1.

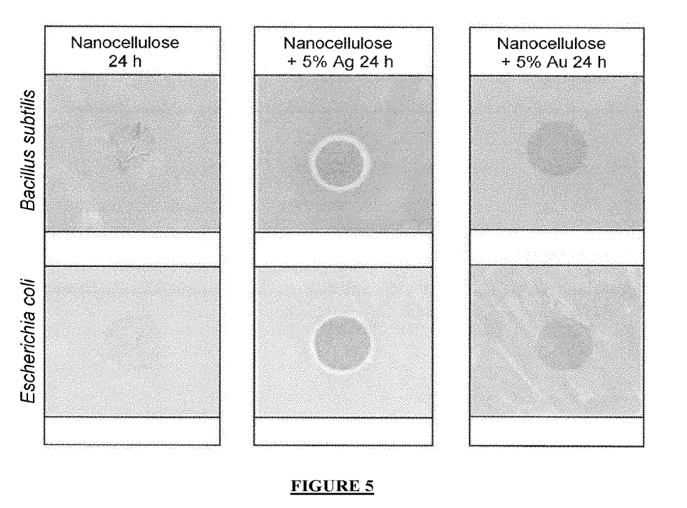

Observation of the cultures, 24 hours after introduction of the nanocellulose incorporating gold nanoparticles, shows the absence of any area of inhibition, which indicates that it does not have antibacterial properties, unlike the sample of nanocellulose incorporating one and the same content of silver nanoparticles (FIG. 5).

### Example 3

Antibacterial Compositions

Antibacterial compositions, incorporating, in addition to the nanocellulose treated according to the invention, mechanical reinforcements (PVP, PVA, latex beads) and optionally a detergent (Triton® X 100), were prepared as described below.

A first series of samples (4 different samples) is prepared by adding, to the dispersion of nanocellulose incorporating 5% by weight of silver nanoparticles, obtained at the end of the process described in example 1, 5% by weight respectively of polyvinylpyrolidone (PVP), of polyvinyl alcohol (PVA) or of latex beads of 100 nm or of 2 μm.

A second series of samples (4 different samples) is prepared by adding, to the dispersion of nanocellulose incorporating 5% by weight of silver nanoparticles, obtained at the end of the process described in example 1, 5% by weight of each of the reinforcements described above for the first series of samples and 5% by weight, relative to the total weight of nanocellulose, of Triton® X 100 detergent.

The antibacterial efficacy of the various compositions thus prepared was tested on the Gram-positive and Gram-negative bacteria, as described in example 1 above.

The compositions of the first series comprising, in addition to the nanocellulose, mechanical reinforcements, without addition of Triton® X 100, show an antibacterial efficacy, after 24 hours of incubation, that is lower than that observed for the dispersion of nanocellulose integrating 5% by weight of silver and free of mechanical reinforcements. In fact, an area of inhibition (ring) around the deposited samples that is less transparent can be observed, this being a sign that not all of the bacteria were destroyed.

The compositions of the second series incorporating reinforcements and supplemented with Triton® X 100 show an antibacterial efficacy, after 24 hours, that is comparable to that observed for the dispersion of nanocellulose integrating 5% by weight of silver in the absence of mechanical reinforcement. In fact, an area of inhibition around the deposited samples that is transparent can be observed; no bacterium remains.

48 hours and 72 hours after incubation, all the samples of the first and second series of nanocellulose incorporating 5% by weight of Ag and mechanical reinforcements, with or without the additional presence of detergent, show a transparent area of inhibition, and thus have good antibacterial activity.

### REFERENCES

[1] Xuezhu et al., “Cellulose Nanocrystals vs. Cellulose Nanofibrils: A comparative study on their microstructures and effects as polymer reinforcing agents”, ACS Appl. Mater. Interfaces 2013, 5, 2999-3009;

[2] Saini et al. “Nisin anchored cellulose nanofibers for long term antimicrobial active food packaging”, RSC Adv. 2016, 6, 12422-12430;

[3] I. Hinkov et al., “Synthése de nanoparticules d'argent par voie micro-onde et leur integration dans des feuilles de cellulose pour des applications agroalimentaires” [“Synthesis of silver nanoparticles by microwave and integration thereof into cellulose sheets for food-processing applications”], Revue de génie industriel [Review of industrial engineering], 2011, 6, 16-22;

[4] Berndt et al. “Antimicrobial porous hybrids consisting of bacterial nanocellulose and silver nanoparticles”, Cellulose 2013, 20:771-783;

[5] Amini et al. “Silver-nanoparticle-impregnated cellulose nanofiber coating for packaging paper”, Cellulose 2016, 23:557-570.

1. A process for antimicrobial treatment using semicrystalline nano- and/or microfibrillated cellulose to which silver nanoparticles are attached, said silver nanoparticles being present in a weight amount strictly greater than 1% and strictly less than 20% relative to the total weight of said cellulose,
said material being obtained with a process comprising at least one step of microwave irradiation of an aqueous dispersion of semicrystalline nano- and/or microfibrillated cellulose supplemented with at least one silver salt, in the presence of a reducing agent.

2. The process according to claim 1, wherein the amount of silver nanoparticles is greater than or equal to 2% by weight, relative to the total weight of said cellulose.

3. The process according to claim 1, wherein the amount of silver nanoparticles is less than or equal to 15% by weight, relative to the total weight of said cellulose.

4. The process according to claim 1, wherein the amount of silver nanoparticles is between 2% and 10% by weight, relative to the total weight of said cellulose.

5. The process according to claim 1, wherein the amount of silver nanoparticles is between 2% and 5% by weight, relative to the total weight of said cellulose.

6. The process according to claim 1, wherein the silver salt is silver nitrate (AgNO3).

7. The process according to claim 1, wherein the reducing agent is chosen from hydrazine, N,N-diethylhydroxylamine, urea, thiourea and mixtures thereof.

8. The process according to claim 1, wherein the aqueous dispersion used for preparing said antimicrobial material comprises a content of semicrystalline nano- and/or microfibrillated cellulose of between 1% and 5% by weight, relative to the total weight of the aqueous dispersion.

9. The process according to claim 1, wherein the aqueous dispersion used for preparing said antimicrobial material comprises a content of semicrystalline nano- and/or microfibrillated cellulose of between 2% and 4% by weight, relative to the total weight of the aqueous dispersion.

10. The process according to claim 1, wherein the aqueous dispersion used for preparing said antimicrobial material comprises a content of semicrystalline nano- and/or microfibrillated cellulose of between 2% and 3% by weight, relative to the total weight of the aqueous dispersion.

11. The process according to claim 1, wherein the preparation of the semicrystalline nano- and/or microfibrillated cellulose to which silver nanoparticles are attached comprises at least the steps consisting in:
(i) providing an aqueous dispersion of semicrystalline nano- and/or microfibrillated cellulose;
(ii) adding at least one silver salt with stirring until said silver salt has totally dissolved;
(iii) adding a reducing agent to the mixture thus obtained; and
(iv) subjecting said mixture to microwave irradiation under conditions conducive to the attachment of said silver nanoparticles to the nano- and/or microfibrillated cellulose.

12. The process according to claim 1, wherein the microwave irradiation has energy of between 200 and 1000 W.

13. The process according to claim 1, wherein said semicrystalline nano- and/or microfibrillated cellulose to which silver nanoparticles are attached forms all or part of an antimicrobial film or coating.

14. The process according to claim 13, wherein said semicrystalline nano- and/or microfibrillated cellulose to which silver nanoparticles are attached forms all or part of an antimicrobial film or coating at the surface of a substrate, said substrate being a film.

15. The process according to claim 14, wherein said film is of cellulose-based nature.

16. An antimicrobial composition comprising at least:
semicrystalline nano- and/or microfibrillated cellulose to which silver nanoparticles are attached in a weight amount strictly greater than 1% and strictly less than 20% relative to the total weight of said cellulose, obtained according to the process defined according to claim 1; and
at least one compound, termed mechanical reinforcement, capable of improving the mechanical properties of a coating formed from said composition.

17. The composition according to claim 16, in which said mechanical reinforcement(s) is (are) chosen from polymer nanoparticles.

18. The composition according to claim 17, wherein said polymer nanoparticles are nanoparticles of natural or synthetic latex, polyvinylpyrrolidone (PVP), polyvinyl alcohol (PVA), and mixtures thereof.

19. The composition according to claim 16, wherein said mechanical reinforcement(s) is (are) present in a content of between 0.5% and 5% by weight relative to the total dry weight of antimicrobial composition.

20. The composition according to claim 16, said composition comprising one or more surfactant(s).

21. The composition according to claim 20, comprising non-ionic surfactant(s).

22. The composition according to claim 20, wherein said surfactant(s) is/are chosen from polyoxyethylene sorbitan monooleate, polyoxyethylene sorbitan monolaurate, octoxinol 10, polyethylene-polypropylene glycol, n-dodecyl-β-D-maltoside (DDM), 3-[(3-cholamidopropyl)dimethylammonio]-1-propanesulfonate and mixtures thereof.

23. The composition according to claim 16, said composition being in liquid form or in solid form.

24. The composition according to claim 16, said composition comprising one or more aqueous solvents.

25. An antimicrobial film or coating formed from a composition as defined according to claim 16.

26. An antimicrobial film or coating according to claim 25, said film or coating having a thickness of between 1 and 500 μm.

27. A process for preparing an antimicrobial film or coating as defined according to claim 25, comprising at least one step (a) of applying, via the aqueous route, a composition, and a drying step (b) suitable for evaporating off said aqueous solvent(s).

28. The process according to claim 27, wherein said composition is applied in step (a) by dip-coating, by spraying, spin depositing, spray-coating, inkjet coating, spin-coating, slot die coating, coating by impregnation, flow-coating, depositing by dipping or by screen printing, depositing by size-press, bar-coating.

29. The process that is of use for conferring antimicrobial properties on a substrate, comprising at least the application, at the surface of said substrate, of a film or coating as defined according to claim 25.

30. The process according to claim 29 wherein said substrate is a film or paper of cellulose-based nature.

31. An article, comprising a substrate coated with at least one antimicrobial film or coating as defined according to claim 25.

32. An article according to claim 31, said article being for food processing.

33. An article according to claim 31, wherein said substrate is a food film based on cellulose.
